(19) United States
(12) Patent Application Publication
(10) Pub. No.: US 2010/0055461 A1
(43) Pub. Date: Mar. 4, 2010

(54) ARTIFICIAL TURF INFILL

(76) Inventors: DANIEL A. DALUISE, Southborough, MA (US); Philip G. Christiansen, West newbury, MA (US)

Correspondence Address: PEARSON & PEARSON, LLP, 10 GEORGE STREET, LOWELL, MA, 01852, US

(21) Appl. No.: 12/198,567

(22) Filed: Aug. 26, 2008

(51) Int. Cl. B32B 5/16

(52) U.S. Cl. 428/403

(57) ABSTRACT

An artificial turf infill comprising an organic material including ground walnut shells having each organic particle completely coated with an anti-microbial agent. Water-retaining particles are added to the infill ranging between 0 and 60% of total weight of the mixture. Synthetic, ecologically-safe resilient granules preferably between approximately 20% and 25% by weight may be added to the infill to improve shock attenuation (lower G-max) properties of the infill mixture. The water-retaining particles and synthetic resilient granules within the infill are completely coated with the anti-microbial agent.

### BACKGROUND OF THE INVENTION

1. Field of the Invention

This invention relates generally to artificial turf playing surfaces for athletic games and, in particular, to an infill particulate material placed in and between artificial blades of grass.

2. Description of the Prior Art

Prior embodiments of artificial turf, commonly called “infilled turf” as disclosed in U.S. Pat. No. 4,337,283, issued Jan. 29, 1982 to Frederick T. Haas, Jr. and in U.S. Pat. No. 5,976,645 issued Nov. 2, 1997 to Daniel A. Daluise et al. represent a great improvement over the original short-pile artificial playing surfaces in that they reduce abrasiveness, increase shock attenuation, improve response to foot and ball actions, and have an improved appearance.

These “infilled” turf systems incorporate an infill (particulate placed in and between the artificial grass blades), consisting of a mixture of rubber and sand or rubber, only. Because of its lower cost, the rubber used is almost exclusively derived from recycled tires. The sand component invariably contains silica. In recent years, much concern has been raised with regard to the environment, ecological, health and safety hazards of these infill components.

Rubber contains many problematic synthetic chemicals, such as polycyclic aromatic hydrocarbons (PAHs) and toxic heavy metals. A number of these PAHs, such as benzopyrene, are known carcinogens. Others, such as lead, zinc and cadmium, also could be harmful to the environment, if introduced through run-off from infilled artificial turf fields. Silica is also a known carcinogen and it is associated with silicosis and other respiratory harm. In addition, any of these materials, when installed as a conventional infill matrix, are believed to promote microbe growth, such as bacteria, fungi and mold. These concerns have promoted development of “safer” infill material alternatives such as thermoplastic elastomers (TPEs) or ethylene-propylene diene monomer (EPDM). Because these synthetic materials are not generally available in recycled form, their cost is a deterrent to their use and, because of cost, they are usually mixed with sand to achieve the full-depth of infill required, at a reasonable cost. Such systems, therefore still suffer the concerns associated with silica sand, including the “Petri-dish effect” on microbe growth.

To circumvent the problems of cost, synthetic inclusion, and sand inclusion, some naturally occurring organic materials have been used. Chief among these has been ground coconut shell. However, coconut shell and other natural organics carry their own set of concerns. Since organic materials provide nutrients for microbes, they not only provide support for microbial growth, but also are susceptible to decomposition actuated by those same microbes.

Other prior art references include U.S. Patent Application Publication No. US2007/0049694 Published Mar. 1, 2007, Inventor Michael Roch, et al. entitled “Use of a Vulcanized Thermoplastic Elastomer or Styrene-Ethylene-Butadiene-Styrene Polymer Infill Material in Artificial Turf System” which discloses the use of, for example, a vulcanized thermoplastic elastomer in artificial turf systems particularly for football fields. However, this use of a vulcanized thermoplastic elastomer carries its own set of problems including high cost for the intended purpose, the perception of ecological risks associated with synthetic chemicals, and the necessity to mix with sand to reduce cost and achieve the proper “feel” and surface response.

Also, U.S. Patent Application Publication No. US2006/0100342 published May 11, 2006, Inventor Victor Jensen, entitled “Coated Sand Grains” discloses a particular material consisting of sand grains coated with a thermoplastic polymer to provide a loose material with properties suitable for use as a surfacing composition, in particular for sports surfaces such as a field of artificial grass. However, this product carries the risk of ecologically harmful run-off from the surface applied thermoplastic polymers, a very high specific gravity and bulk-density, which greatly increases the weight of material required for a given depth of infill thus increasing total material cost and dramatically increasing freight costs, and the negative features of sand whereby it compacts over time thus inhibiting drainage and reducing shock attenuation.

Further, U.S. Patent Application Publication No. US 2006/0172092, published Aug. 3, 2006, inventor Christopher Tetrault, entitled “Synthetic Turf Having Cooling Layer” discloses a synthetic turf for landscaping and athletic fields having a cooling layer to substantially dissipate heat buildup common with synthetic turf. A particular infill is introduced between grass-like filaments of the synthetic turf covering comprising a super absorbent material such as polyacrylamide or polyacrylate. The hydrophilic material swells in water or other introduced liquids to about 200 to about 400 times its density. However, this design carries the disadvantage of changing dimension (swelling) in water, which changes the surface configuration by increasing infill depth. This results in a change in surface performance characteristics, as well as a change in surface response or “feel”. In addition, the synthetic chemicals still carry the perceived ecological risks associated with exposure to synthetic chemicals. Cost is also high for the intended use in athletic surfaces.

U.S. Pat. No. 6,818,274, issued Nov. 16, 2004 to Mark E. Buch, et al, entitled “Artificial Turf System Using Support Material For Infill Layer” discloses an artificial turf system comprising an infill of particulate material disposed between turf fibers upon an upper layer of turf backing. The infill layer may include a base course of ceramic support material. A top course may be resilient particles and provide cushioning or shock absorption. However, this system is relatively high in cost for the intended use, requires the incorporation of “resilient particles” which are potentially environmentally and ecologically unsafe, and does not address the microbial growth problem.

### SUMMARY OF THE INVENTION

Accordingly, it is therefore an object of the present invention to provide an organic and/or inorganic artificial turf infill that is free of any synthetic chemicals, free of silica sand, environmentally-friendly, ecologically-safe, and non-supportive of microbial growth, and therefore resistant to decomposition.

It is another object of this invention to provide an artificial turf “infill” that is a naturally occurring organic hard material such as walnut shell, peanut shell, corn cob, pecan shell, or hard pit material such as olive stone, but the preferred material is walnut shell.

It is yet another object of this invention to provide an organic substance mixed with the natural inorganic material that absorbs and retains water, such as pozzolan, vermiculite, perlite, cork, or calcined clay, with the preferred inorganic additive being pozzolon because of its specific gravity being similar to walnut shells.

It is a further object of this invention to provide a shock attenuating matrix sufficient to meet the requirement consistent with its use in an athletic surface, landscape grass or play-area safety surface.

It is a further object of this invention to provide an infill material with higher albedo and increased water absorption and retention capacity, thus increasing the capability to reduce surface temperature of the artificial turf through evaporative cooling.

It is yet another object of this invention to prevent microbial propagation in the infill matrix to not only prevent bacteria, fungi and mold growth but also to inhibit the decomposition of the organic materials actuated by microorganisms.

These and other objects are further accomplished by an artificial turf infill comprising organic particles and an anti-microbial agent applied to cover each of the organic particles to prevent decomposition of the organic particles. The organic particles preferably comprise ground walnut shells, and the organic particles may comprise one of a group consisting of ground coconut shells, ground pecan shells, ground peanut shells, ground corn cobs, and olive stones. The organic particles comprise a sieve-size in the range of 8 to 50. The infill comprises water retaining particles ranging between 0 and 60% of the total weight of said infill, each of the water retaining particles being covered with the anti-microbial agent. The water retaining particles comprise pozzolon, or may comprise one of a group consisting of vermiculite and calcined clay. The infill further comprises ecologically-sate, resilient synthetic granules, coated with the anti-microbial agent, to improve shock attenuating qualities of the infill when installed in the artificial turf.

The objectives are further accomplished for preparing the artificial turf infill by the process of grinding an organic hard material to form particles, and spraying an anti-microbial agent to completely coat each of the particles of the ground organic material thereby preventing decomposition of the ground organic particles. The step of grinding an organic hard material comprises the step of grinding walnut shells. The step of grinding an organic hard material to form particles comprises the step of grinding one of a group consisting of coconut shells, pecan shells, peanut shells, corn cobs, and olive stones. The process comprises the step of grinding the particles to a sieve-size in the range of 8 to 50. The process comprises the step of adding water retaining particles to the infill ranging between 0 and approximately 60% of the total weight of the infill prior to spraying the infill with the anti-microbial agent. The process further comprises the step of adding an ecologically-safe, resilient synthetic granules to the infill to improve shock attenuating properties of the infill prior to spraying the infill with the anti-microbial agent. The step of adding ecologically-safe, resilient synthetic granules to the infill comprises the step of adding a thermoplastic elastomer.

The objectives are further accomplished by the use of particles of a ground organic material, each of the particles coated with an anti-microbial agent to prevent decomposition of the particles, as infill material in an artificial turf system, wherein ground organic material comprises ground organic hard shells, such as walnut shells, or one of the group consisting of coconut shells, pecan shells, peanut shells, corn cobs, and olive stones. The use of particles of a ground organic material coated with an anti-microbial agent as infill material in the artificial turf system may further include water retaining particles coated with an anti-microbial agent, varying between 0 and 60% of the total weight of the infill. The water retaining particles comprise one of the group consisting of pozzolon, vermiculite and calcined clay, as infill material in the artificial turf system. The use of particles of a ground organic material coated with an anti-microbial agent as infill material in said artificial turf system may further include synthetic, ecologically-safe resilient granules coated with said anti-microbial agent preferably between approximately 20% and 25% by weight to improve shock activation properties.

Additional objects, features and advantages of the invention will become apparent to those skilled in the art upon consideration of the following detailed description of the preferred embodiments exemplifying the best mode of carrying out the invention as presently perceived.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a cross-sectional view of an artificial turf system comprising an infill according to the present invention.

FIG. 2 is a cross-sectional view of another embodiment of an artificial turf having straight and curved yarns surrounded by an infill according to the present invention.

FIG. 3 is a flow chart of the process for making infill products according to the present invention.

### DESCRIPTION OF ILLUSTRATIVE EMBODIMENTS

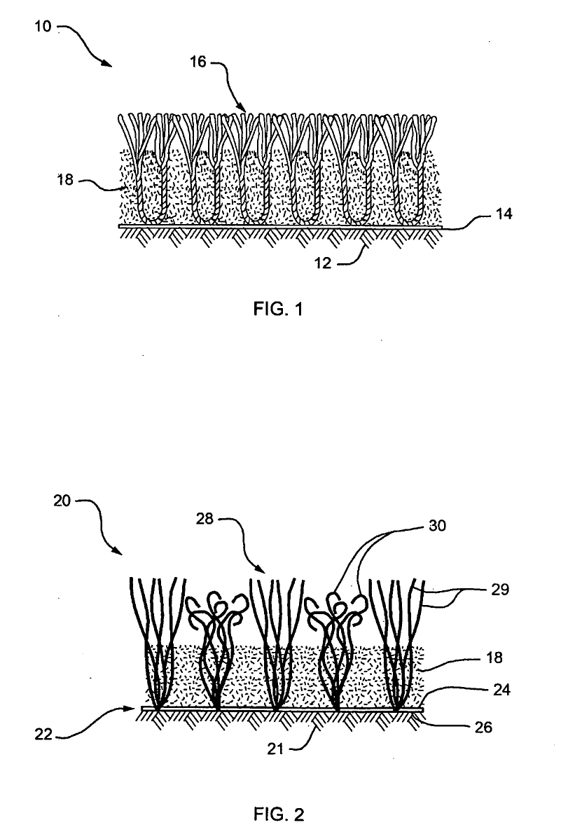

Referring to FIG. 1, a cross-sectional view of an artificial turf system 10 comprising an aggregate turf base 12, a backing 14 made of woven or non-woven material, a pile fabric 16 tufted in the backing 14 and an infill 18 in the space around the filaments of the pile fabric 16 according to the present invention.

Referring to FIG. 2, a cross-sectional view of another artificial turf system 20 comprising of a aggregate turf base 21, a backing 22 made of woven or non-woven sheet material, a pile fabric 28 tufted in the backing 22, and the infill 18 in the space around the filaments of the pile fabric 28 which is a resilient granular material. The pile fabric 28 comprises a straight yarns 29 and curled yarns 30 tufted in the backing 22 in alternating stitch lines.

The backing 22 of the artificial turf system 20 comprises a primary backing 24 and a secondary backing 26 and it is sufficiently permeable. If the secondary backing 26 is impermeable, it should have plural holes (not shown) to allow rainwater to reach drainage means. The primary backing 24 may be made of one to three layers of woven and/or non-woven fabrics. Generally these fabrics are made of polypropylene, polyester or other synthetic materials. While a two-layer structure of the primary backing 24 is the most common, the preferred construct is three layers with the outside layers comprised of a woven and fleeced material known in the trade as “FLW”, and the center layer comprised of a dimensionally stabilizing woven or non-woven material. The total weight of the primary backing 24 can vary between 3 ounces per square yard and 12 ounces per square yard, with the preferred total weight at 10 ounces per square yard. The secondary backing 26 is a polymeric coating, which is formed by applying a liquid polymer on the primary backing 24. The polymeric coating is usually of latex of urethane, with urethane being the preferred type. The coating weight varies between approximately 12 ounces per square yard and approximately 30 ounces per square yard, with 28 ounces per square yard of urethane being the preferred weight. Many other types of artificial turfs or artificial turf systems requiring an infill 16, 18 may use the infill of the present invention, including non-perforated permeable backings, which may or may not use hot-melt coatings in lieu of urethane and may contain primary backing layers which are all woven.

The depth of the infill 18 is between approximately ⅛ inch and approximately 2.75 inches, with the preferred depth at approximately 1.75 inch. The height of yarn filaments above the infill 18 is between approximately ½ inch and 1.5 inches, with the preferred height at approximately ¾ inch.

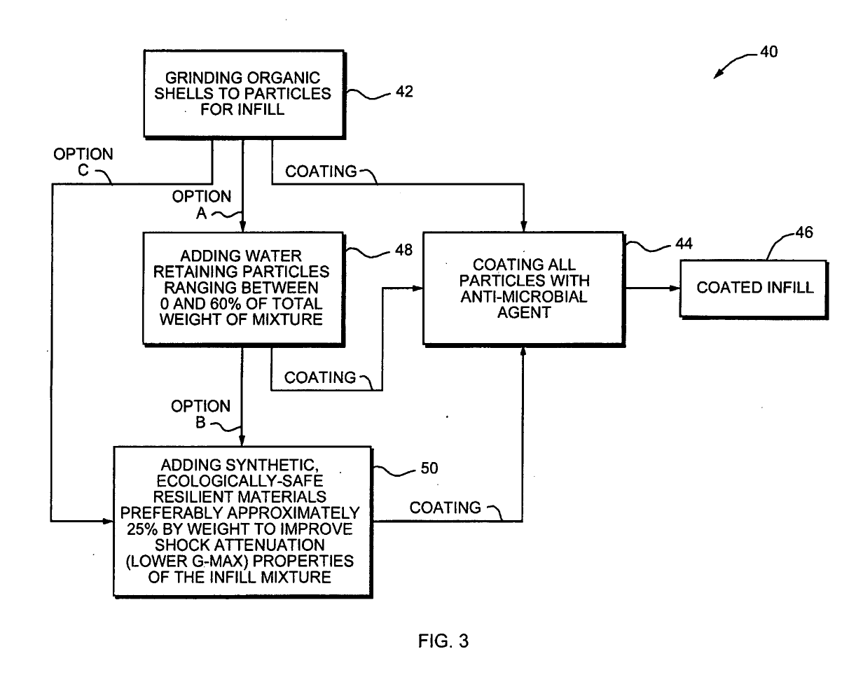

Referring to FIG. 3, a flow chart is shown of the process 40 for making coated infill products according to the present invention. The infill 18 comprises natural organic particles made by the process of grinding in step 42 organic hard material, preferably walnut shells because of their ideal specific gravity which is above 1 to prevent floating, but under 1.5 to minimize material requirements and related freight costs. Other hard materials that may be used instead of walnut shells include coconut shells, pecan shells, peanut shells, corn cobs, and olive stones. However, the preferred hard organic material is walnut shell. The grinding may be accomplished by a standard granulator such as manufactured by Cumberland Engineering Corp. of Attleboro, Mass. or by standard corrugated nip-roll cracker mill such as manufactured by Armex, Inc. of Akron, Ohio. All ground walnut shell particles are 100 W coated with an effective anti-microbial agent in step 44, and the anti-microbial agent is preferably a spray applied in sufficient quantity to the natural infill particles as they drop through a circular configuration of positioned spray nozzles which insures complete and total coating of each particle of the ground walnut shells or other particles provided for coating. The anti-microbial agent may be embodied by Aegis Microbe Shield® manufactured by Aegis Environments of Midland, Mich.

However, because of the anionic nature of the preferred walnut shell material, as well as its tendency to vary in porosity, the coverage and effectiveness of the anti-microbial coating may be inconsistent. In order to insure the most effective and complete anti-microbial coating, a pre-coated resin primer may be applied and dried before application of the anti-microbial agent. The pre-coating equipment may be embodied by a tumble applicator feeding to a fluid-bed dryer, known in the art, but any continuous method of application and subsequent drying may be used. The resin pre-coat material may be obtained from Aegis Environments of Midland, Mich.

The coated infill after step 44 may be packaged in step 46. The anti-microbial agent protects against and prevents the growth of bacteria, fungi, and mold. It is non-toxic, hypoallergenic, non-sensitizing and non-irritating to human skin because the microbe killing mechanism is mechanical, rather than by chemical toxicity, it does not wash-off nor is it consumed or distillated in the execution of its protection. The infill particles have a sieve-size ranging between 8 and 50, with preferable ranges of 18-40 or 14-30. Other coating application methods may be employed as long as the application is sufficient to render the entirety of particles lethal to microorganisms and, therefore, resistant to decomposition as actuated by microorganisms.

In step 48, which is option A, water retaining particles are added to the organic infill particles ranging between 0 and 60% of the total weight of the mixture depending on the predetermined need for evaporative cooling as determined by the climatic location of the surface installation. In step 44 the mixture from step 48, which includes organic particles and water retaining particles, has all particles coated with the anti-microbial agent. The resulting coated infill mixture then may be packaged for distribution at step 46. Preferably, the option A coated infill at step 48 comprises a mixture of 1% pozzolon and 99% ground walnut shells. The water retaining particles of the infill in step 48 may alternatively contain up to 60% by volume of a moisture modifier such as vermiculite and calcined clay. The coated infill after step 46 may be interspersed among the filaments of the pile fabrics 16 and 28 in FIG. 1 and FIG. 2.

Still referring to FIG. 3, in step 50, another embodiment of the infill, option B, is provided by adding to the mixture from step 48 a proportion of synthetic, ecologically-safe resilient materials or granules to improve shock attenuation (lower G-max) properties of the infill mixture, when installed in artificial turf. These resilient materials may include ethylene-propylene diene monomer(EPDM), other thermoplastic elastomers or any resilient inorganic or organic material that is not ecologically harmful. The percentage of resilient granules may be between 0 and 75%, by weight, but preferably between approximately 20% and 25%. After the resilient granules are added to the infill mixture in step 50, all particles, which includes organic particles, water retaining particles and resilient granules, are coated with the anti-microbial agent in step 44. At step 46, the coated infill mixture is packaged for distribution.

Option C comprises adding to the ground organic shells from step 42 a proportion of the synthetic, ecologically-safe resilient materials or granules, such as EPDM or other thermoplastic elastomers, in step 50 to improve shock attenuation (lower G-max) properties of the resulting infill mixture when installed in artificial turf. After the resilient granules are added to the infill mixture in step 50, all particles and granules, which include the ground organic shell particles and the resilient granules, are completely coated with the anti-microbial agent in step 44. Again at step 46, the coated infill mixture from step 44 is packaged for distribution.

The coated infill after step 46 is used in applications where it is infused (infilled) into an artificial turf product at an infill installation site in a specified weight and depth. The coated infill is used in athletic fields, landscaping, play areas (safety turf) and in other artificial turf applications wherein it may be referred to as an artificial grass, synthetic grass, synthetic turf, false grass etc. The coated infill including all particles or granules contains no synthetic chemicals, and therefore, contains no polycyclic aromatic hydrocarbons (PAHs), no butylated hydroxyanisole (known carcinogens found in ambient ground or cryogenically ground recycled-tire-rubber), no silica-sand or sand or any other particulate known to cause respiratory irritation. Therefore, the infill according to the invention eliminates exposure to carcinogens, respiratory exposure to toxic or irritant particulate from rubber dust or silica-sand, ingestion of toxic chemicals by children, as well as run-off contamination of an aquifer by infill materials.

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications, those skilled in the art will recognize that its usefulness is not limited thereto and that the present invention can be beneficially utilized in any number of environments and implementations where it is desirable to use infill in an artificial turf. Accordingly, the claims set forth below should be construed in view of the full breadth and spirit of the invention as disclosed herein.

What is claimed is:

1. An artificial turf infill comprising:
organic particles; and
an anti-microbial agent applied to cover each of said organic particles to prevent decomposition of said organic particles.

2. The artificial turf infill as recited in claim 1 wherein said organic particles comprise a ground organic, hard shell or a pit material.

3. The artificial turf infill as recited in claim 1 wherein said organic particles comprise ground walnut shells.

4. The artificial turf infill as recited in claim 1 wherein said organic particles comprise one of a group consisting of ground coconut shells, ground pecan shells, ground peanut shells, ground corn cobs, and olive stones.

5. The artificial turf infill as recited in claim 1 wherein said particles comprise a sieve-size in the range of 8 to 50.

6. The artificial turf infill as recited in claim 1 wherein said infill comprises water retaining particles ranging between 0 and 60% of the total weight of said infill, each of said water retaining particles being covered with said anti-microbial agent.

7. The artificial turf infill as recited in claim 6 wherein said water retaining particles comprise pozzolon.

8. The artificial turf infill as recited in claim 6 wherein said water retaining particles comprise one of a group consisting of vermiculite and calcined clay.

9. The artificial turf infill as recited in claim 1 wherein said infill further comprises ecologically-safe, resilient synthetic granules, coated with said anti-microbial agent, to improve shock attenuating qualities of said infill when installed in said artificial turf.

10. The artificial turf infill as recited in claim 6 wherein said infill further comprises ecologically-safe, resilient synthetic granules, coated with said anti-microbial agent, to improve shock attenuating qualities of said infill when installed in said artificial turf.

11. The artificial turf infill as recited in claim 9 wherein said infill comprises a percentage by weight of resilient synthetic granules in the range between 0 and 75%.

12. The artificial turf infill as recited in claim 9 wherein said resilient synthetic granules comprise a thermoplastic elastomer.

13. An artificial turf infill prepared by the process of:
grinding an organic hard material to form particles; and
spraying an anti-microbial agent to completely coat each of said particles of said ground organic material thereby preventing decomposition of said ground organic particles.

14. The process as recited in claim 13 wherein said step of grinding an organic hard material comprises the step of grinding walnut shells.

15. The process as recited in claim 14 wherein said step of spraying an anti-microbial agent to completely coat each of said particles comprising said ground walnut shells comprises the step of pre-coating said ground walnut shells with a resin primer prior to spraying said anti-microbial agent.

16. The process as recited in claim 13 wherein said step of grinding an organic hard material to form particles comprises the step of grinding one of a group consisting of coconut shells, pecan shells, peanut shells, corn cobs, and olive stones.

17. The process as recited in claim 13 wherein said process comprises the step of grinding said particles to a sieve-size in the range of 8 to 50.

18. The process as recited in claim 13 wherein said process comprises the step of adding water retaining particles to said infill ranging between 0 and approximately 60% of the total weight of said infill prior to spraying said infill with said anti-microbial agent.

19. The process as recited in claim 13 wherein said process further comprises the step of adding an ecologically-safe, resilient synthetic granules to said infill to improve shock attenuating properties of said infill prior to spraying said infill with said anti-microbial agent.

20. The process as recited in claim 19 wherein said step of adding ecologically-safe, resilient synthetic granules to said infill comprises the step of adding a thermoplastic elastomer.

21. Use of particles of a ground organic material, each of the particles coated with an anti-microbial agent to prevent decomposition of said particles, as infill material in an artificial turf system.

22. The use of particles as recited in claim 21 wherein said ground organic material comprises ground organic hard shells or pit material.

23. The use of particles as recited in claim 21 wherein said ground organic material comprises walnut shells.

24. The use of particles as recited in claim 21 wherein said ground organic material comprises one of the group consisting of coconut shells, pecan shells, peanut shells, corn cobs, and olive stones.

25. Use of particles of a ground organic material, each of the particles coated with an anti-microbial agent, as infill material in artificial grass.

26. The use of particles as recited in claim 25 wherein said ground organic material comprises ground organic hard shells or pit material.

27. The use of particles as recited in claim 25 wherein said ground organic material comprises walnut shells.

28. The use of particles as recited in claim 25 wherein said ground organic material comprises one of the group consisting of coconut shells, pecan shells, peanut shell, corn cobs, and olive stones.

29. The use of particles of a ground organic material, each of the particles coated with an anti-microbial agent, as recited in claim 21 further including water retaining particles, coated with said anti-microbial agent, varying between 0 and 60% of the total weight of said infill, as infill material in said artificial turf system.

30. The use of particles of a ground organic material, each of the particles coated with said anti-microbial agent as recited in claim 29 wherein said water retaining particles comprise one of the group consisting of pozzolon, vermiculite and calcined clay, as infill material in said artificial turf system.

31. The use of particles of a ground organic material, each of the particles coated with an anti-microbial agent as recited in claim 21 and further including synthetic, ecologically-safe resilient granules coated with said anti-microbial agent preferably between approximately 20% and 25% by weight to improve shock activation properties, as infill material in said artificial turf system.
